(19) United States
(12) Patent Application Publication
(10) Pub. No.: US 2012/0040442 A1
(43) Pub. Date: Feb. 16, 2012

(54) METHOD FOR USE IN PALM OIL MILL EFFLUENT (POME) TREATMENT

(76) Inventors: Anwar AHMAD, Kuantan (MY); Rumana Ghufran, Kuantan (MY); Zularisam Abdul Wahid, Kuantan (MY)

(21) Appl. No.: 12/978,287

(22) Filed: Dec. 23, 2010

(30) Foreign Application Priority Data
Aug. 12, 2010 (MY) PI2010003799

(51) Int. Cl. C02F 3/28

(52) U.S. Cl. 435/262

(57) ABSTRACT

The present invention discloses a method for use in treating palm oil mill effluent (POME). Said method comprising the steps of: treating the palm oil mill effluents with concentrated butyrate; introducing the treated palm oil mill effluents into a reaction tank (11) with loading rate of at least 1.5 g COD/L/d and at least 4 days of hydraulic retention time; and providing microorganism biomass in the reaction tank so that anaerobic degradation of the palm oil mill effluents treated with butyrate can be performed. Preferably, the optimum condition for degradation of the palm oil mill effluents in the reaction tank is at constant temperature 37° C. with pH value of approximately 6.5-7.5.

### FIELD OF INVENTION

The present invention relates to palm oil mill effluents treatment method. More particularly, relates to a treatment of palm oil mill effluents using butyrate in an up-flow anaerobic sludge blanket reactor (UASBR).

### BACKGROUND OF THE INVENTION

Palm oil mill effluent (POME) is a viscous brown liquid containing fine suspended solid, which generally generated through the process of palm oil milling, especially through the operations of sterilizing palm fruits and clarifying and hydrocloning the palm oil. The palm oil mill effluent can contribute to a severe aqueous pollution if it is untreated properly and discharged directly into the environment. This is mainly due to its high biochemical oxygen demand and chemical oxygen demand concentration.

In the past decade, there are many approaches have been introduced to overcome the pollution problems associated with the palm oil mill effluent. The approaches include simple skimming device, land disposal, ultrafiltration, bioremediation, chemical coagulation and flotation, membrane technology, treatment by marine yeast, evaporation, pond system, up-flow anaerobic sludge blanket reactor, and various aerobic and anaerobic microorganism processes.

Among the above-mentioned approaches, the up-flow anaerobic sludge blanket reactor (UASBR) is the most promising method for use in palm oil mill effluent treatment. The UASBR is one of the anaerobic digestion methods, which involves degradation of complex organic matter under the absence of oxygen. In UASB reactor, biomass containing anaerobic active biomass settled at the bottom of the reactor is mechanically mixed by the up-flow forces of the incoming aqueous organic matter. For this reason, low energy consumption is achieved in using UASBR method.

Furthermore, production of methane for renewable energy makes the UASBR has a stronger advantage over the other alternative methods. However, there are some drawbacks observed in this method. As an anaerobic treatment method, the UASBR is often encountered with a long start-up period and long retention time, especially when granulated seed sludge is not used. In addition, low up-flow velocities of the reactor can lead to slow operation rate.

The primary object of the present invention is to overcome all the above mentioned drawbacks. It is especially directed to enhance the performance of the existing anaerobic degradation based palm oil mill effluent treatment so that the start-up period and hydraulic retention time can be reduced.

It is yet another object of the present invention is to optimize the production of methane throughout the anaerobic degradation based palm oil mill effluent treatment.

### SUMMARY OF THE INVENTION

In one embodiment of the present invention, disclosed a method for use in treating palm oil mill effluents (POME). Said method comprising the steps of: treating the palm oil mill effluents with concentrated butyrate; and introducing the treated palm oil mill effluents into an up-flow anaerobic sludge blanket reactor with a loading rate ranging from 1.5-4.8 g COD/L/d and hydraulic retention time varying from approximately 4-11 days. Microorganism biomass is provided in the reactor so that anaerobic degradation of the palm oil mill effluents treated with butyrate can be performed. The optimum condition for anaerobic degradation of the palm oil mill effluents is under pH value ranging from 6.5-7.5 at 37° C.

Preferably, the anaerobic degradation of the palm oil mill effluents appear as an efficient treatment since there are up to 99.4% palm oil mill effluents have been degraded at COD loading rate of 1.5-4.8 g COD/L/d and hydraulic retention time of 7.2 days. Furthermore, approximately of 20.17 L/day biogas with approximately of 70-80% methane contents therein is obtained throughout the treatment operation.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views

FIG. 1 illustrates the setup of upflow anaerobic sludge blanket reactor (UASBR) system embodying the present invention.

### DETAILED DESCRIPTION OF THE PREFERRED EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures and/or components have not been described in detail so as not to obscure the invention. Reference will now be made in detail to the preferred embodiments of the present invention, examples of which are illustrated in the accompanying drawings.

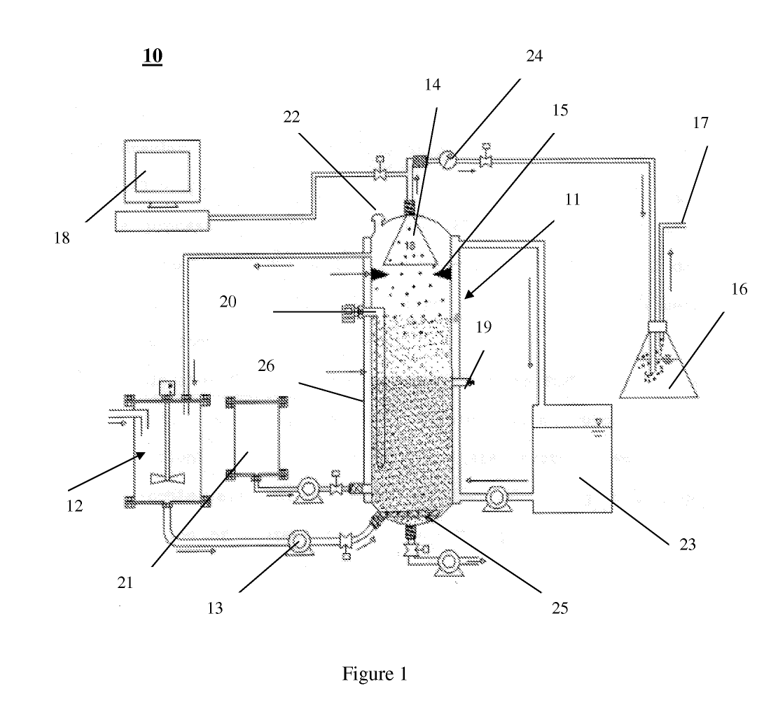

FIG. 1 illustrates the setup of an Upflow Anaerobic Sludge Blanket (UASBR) system, which is provided for palm oil mill effluent (POME) treatment. The UASBR system (10) includes a reaction tank (11), where anaerobic degradation of the palm oil mill effluent is carried out. The reaction tank (11) is directly fed with the palm oil mill effluent supplied from a holding tank (12) through a peristaltic pump (13) provided at the lower portion of the reaction tank (11).

Inside the reaction tank (11), a liquid splitter (25) is provided to separate the residual water of the palm oil effluent to be treated from the sludge or biomass present in the tank (11). A biogas collector (14) is installed at the upper portion of the reaction tank (11) to collect the gaseous generated from the anaerobic degradation of the palm oil mill effluent therein. Beneath the biogas collector (14), there is provided a plurality of baffles (15), which serve as a means for directing the gaseous to the opening provided at the biogas collector (14). A biogas separator (16) connects to the biogas collector (14) and thereby facilitates methane gas separation from the collected biogas in the biogas collector (14). The separated methane gas is then passed into a methane gas holder (17).

A biogas pipe (18) extended from the biogas collector (14) connecting to a gas chromatography apparatus (18) for determining and characterizing the content of resulted gaseous from the degradation operation of the palm oil mill effluent in the reaction tank (11). It is noted that the UBSR (10) system is equipped with a sampling port (19), pH and temperature indicator (20), NaHCO₃ dosing tank (21), pressure controller (22), hot water tank (23) and biogas flow meter.

Preferably, the reaction tank is made up of plexiglass with a diameter of 10 cm and a height of 60 cm. The volume of the reaction tank is approximately 4.5 liters. To ensure the anaerobic degradation of the palm oil mill effluent to be operated at a constant temperature of 37° C., the reaction tank is complemented with water jacket (26).

In one embodiment of the present invention, palm oil mill effluent was treated with concentrated butyrate in the holding tank (12) prior to the step of being fed into the reaction tank (11) of the Anaerobic Sludge blanket Reactor (UASBR) (10) system embodying the present invention. Preferably, butyrate serves as an intermediate in the anaerobic degradation of organic matter. In a sulphate-depleted environment, butyrate added into the palm oil mill effluent in the reaction tank is oxidized to acetate by acetogens, and thus converted into methane and carbon dioxides by acetolastic methanogens and hydrogen utilizing methanogens.

More suitably, the degradation of butyrate in palm oil mill effluent to acetyl CoA involves beta-oxidation pathways. Said pathway comprises the following steps: Activation of butyrate by coenzyme A to form butyryl-CoA, which is then, converted crotonyl-CoA with the aid of butyryl-CoA dehydrogenase. The resultant crotonyl-CoA catalyzed by crotonase and generates 3-hydroxy butyrtl-CoA. Subsequently, NAD-linked dehyrogenase oxidizes the resultant 3-hydroxy butyryl-CoA to form acetoacetyl CoA. Acetly-CoA is formed after thiolytic cleavage of acetoacetyl-CoA. The acetyl-CoA is then metabolized to acetate with concomitant ATP production. The generated acetate is cleaved to form methane and carbon dioxide by acetoclastic methanogens. The carbon dioxide is further reduced into methane by hydrogen utilizing methanogen.

In a preferred embodiment of the present invention, the palm oil mill effluent to be purified was initially loaded into the reaction tank (11) with a COD loading rate of approximately 1.5 g L⁻¹ d⁻¹. In other words, in corresponding to the initial loading rate, the concentration of the effluent to be purified time of roughly 11 days. The anaerobic degradation of the palm oil mill effluent could be performed optimally under a nearly neutral condition, which the pH is ranging from 6.5-7.5 at 37° C. The constant pH condition could be achieved by adding a suitable dose of NaHCO3 into the reaction tank (11). Preferably, the COD loading rate had to be increased gradually only when the COD removal efficiency reached over 85%.

Previously studies showed the COD removal efficacy of a UASBR system (10) is highly dependent on the COD loading rate and insensitive to either HRT or the COD level in the palm oil mill effluent. Therefore, in one embodiment of the present invention, the COD loading rate could be increased by either increasing the butyrate concentration in the palm oil mill effluent is or by reducing the hydraulic retention time (HRT). The adjustment of the COD loading in corresponding to the HRT and COD level is summarized in Table 1.

TABLE 1
Palm Oil Mill Effluent COD, HRT, and COD loading Rate

| | COD loading of palm | Hydraulic Retention | COD loading rate |
|---|---|---|---|
| Days | oil mill effluent (mg L⁻¹) | Time (HRT) | (g L⁻¹ d⁻¹) |
| 1-4 | 16500 | 11 | 1.5 |
| 5-10 | 17500 | 11 | 1.59 |
| 11-21 | 18000 | 11 | 1.64 |
| 22-33 | 19500 | 11 | 1.77 |
| 34-50 | 20500 | 10.4 | 1.97 |
| 51-56 | 23500 | 10.6 | 2.22 |
| 57-65 | 27500 | 9.4 | 2.93 |
| 66-70 | 31500 | 8.6 | 3.67 |
| 71-74 | 34500 | 7.2 | 4.80 |
| 75-80 | 38500 | 6.4 | 6.01 |
| 81-85 | 42500 | 5.8 | 7.33 |
| 86-90 | 46000 | 4 | 11.5 |

TABLE 2
Results Obtained at Each Loading after A Steady State
Condition During Anaerobic Treatment of Palm Oil Mill Effluent.

| COD | Total VFA | Alkalinity | | Effluent VFA | Methane | Gas | Biogas | COD |
|---|---|---|---|---|---|---|---|---|
| loading rate | concentration | (mgNaHC₃/ | | concentration | production | composition | production | reduction |
| (g L⁻¹ d⁻¹) | (mg/L) | L) | TVFA/Alkalinity | (mg/l) | (L/day) | (CH₄ %) | (L/day) | (%) |
| 1.5 | 905.45 | 4992.32 | 0.1814 | 60 | 1.6 | 73 | 2.71 | 97.0 |
| 1.59 | 926.24 | 4997.26 | 0.1854 | 55 | 7.3 | 78 | 9.25 | 97.8 |
| 1.64 | 978.53 | 4878.69 | 0.2000 | 85 | 3.6 | 70 | 5.11 | 80.0 |
| 1.77 | 1023.24 | 4378.42 | 0.2340 | 45 | 9.3 | 72 | 12.82 | 98.5 |
| 1.97 | 1057.68 | 4246.85 | 0.2490 | 25 | 11.8 | 74 | 15.93 | 97.6 |
| 2.22 | 1071.39 | 4195.73 | 0.2553 | 20 | 12.9 | 75 | 17.24 | 98.8 |
| 2.93 | 1085.59 | 4072.65 | 0.2665 | 14 | 14.9 | 75 | 19.71 | 99.0 |
| 3.67 | 1120.38 | 3997.96 | 0.2802 | 15 | 15.2 | 80 | 19.82 | 98.9 |
| 4.80 | 1148.73 | 3782.47 | 0.3036 | 12 | 16.2 | 77 | 20.17 | 99.4 |
| 6.01 | 1163.94 | 3698.79 | 0.3146 | 14 | 13.6 | 76 | 17.80 | 82.0 |
| 7.33 | 1178.58 | 3596.23 | 0.3302 | 23 | 10.9 | 73 | 14.87 | 73.0 |
| 11.5 | 1192.64 | 3259.35 | 0.3603 | 25 | 9.6 | 71 | 13.42 | 85.0 |

According to Table 2, 97-99.4% of COD are removed when the palm oil mill effluent is treated with concentrated butyrate in the upflow anaerobic sludge blanket reactor (UASBR) system (10) at loading rate up to 1.5-4.8 g COD/L/d by varying hydraulic retention time (11-7.2 days). Preferably, 99.4% of COD removal and production of biogas up to 20.17 L/day is achieved when the COD loading rate is 4.8 g/L/day and the hydraulic retention time of 7.2 days. Furthermore, at such COD loading rate, 16.2 g/L/day of methane is generated. It should be noted that at least 70-80% of methane gaseous can be recovered from the biogas resulted from the anaerobic degradation process.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

1. A method for use in treating palm oil mill effluents (POME), comprising the steps of:
treating the palm oil mill effluents with concentrated butyrate;
introducing the treated palm oil mill effluents into an reaction tank (11) with an loading rate of at least 1.5 g COD/L/d and hydraulic retention time of at least 4 days; and
providing microorganism biomass at the reaction tank (11) so that anaerobic degradation of the palm oil mill effluents treated with butyrate can be performed.

2. A method for use in treating palm oil mill effluents as claimed in claim 1, further comprising the step of increasing the loading rate gradually when approximately 85% of palm oil mill effluents have been degraded.

3. A method for use in treating palm oil mill effluents as claimed in claim 1, further comprising the step of maintaining the pH condition of the palm oil mill effluents to be degraded in the reaction tank (11), wherein the pH value is ranging from approximately 6.5-7.5.

4. A method for use in treating palm oil mill effluents as claimed in claim 1, further comprising the step of providing a constant reaction temperature for the anaerobic degradation of palm oil mill effluent in the reaction tank (11).

5. A method for use in treating palm oil mill effluents as claimed in 4, wherein said the constant reaction temperature is approximately 37° C.

6. A method for use in treating palm oil mill effluents as claimed in claim 1, wherein said microorganism biomass is selected from a group of microorganism that having an ability to degrade the butyrate in the palm oil mill effluent.

7. A method for use in treating palm oil mill effluents as claimed in claim 6, wherein said microorganism biomass includes but not limiting to acetogens, acetoclastic methanogens, and hydrogen utilizing methanogens.

8. A method for use in treating palm oil mill effluents as claimed in claim 1, wherein said loading rate of palm oil mill effluents into the reaction tank is ranging from 1.5-4.8 g COD/L/d.

9. A method for use in treating palm oil mill effluents as claimed in claim 1, wherein said hydraulic retention time of loading palm oil mill effluents into the reaction tank is ranging from 4-11 days.

10. A method for use in treating palm oil mill effluents as claimed in claim 1, wherein the optimum loading rate of palm oil mill effluents into the reaction tank is approximately 4.8 g/L/day.

11. A method for use in treating palm oil mill effluent as claimed in claim 1, wherein the optimum hydraulic retention time of loading palm oil mill effluent into the reaction tank (11) is approximately 7.2 days.

12. A method for use in treating palm oil mill effluent as claimed in claim 1, wherein said the reaction tank (11) is an up-flow anaerobic sludge blanket reactor (UASBR) (10).

13. A method for use in treating palm oil mill effluent as claimed in claim 2, wherein the step of increasing the loading rate is performed either by increasing the butyrate concentration in the palm oil mill effluents or by reducing the hydraulic retention time (HRT).

14. A method for use in treating palm oil mill effluent as claimed in claim 3, wherein the step of maintaining the pH value of the palm oil mill effluents is performed by adding an appropriate dose of NaHCO₃.
